(19) United States
(12) Patent Application Publication
(10) Pub. No.: US 2006/0204208 A1
(43) Pub. Date: Sep. 14, 2006

(54) Method for controlled recording to an interconnected ieee-1394 compliant device

(76) Inventors: Mark Gilmore Mears, Zionsville, IN (US); Chad Andrew Lefevre, Indianapolis, IN (US); Benoit Pol Menez, Carmel, IN (US); Joseph Wayne Forler, Zionsville, IN (US); Aaron Hal Dinwiddie, Cicero, IN (US); Eric Stephen Carlsgaard, Zionsville, IN (US)

Correspondence Address: THOMSON LICENSING INC., PATENT OPERATIONS, PO BOX 5312, PRINCETON, NJ, 08543-5312, US

(21) Appl. No.: 10/555,359

(22) PCT Filed: May 5, 2004
(86) PCT No.: PCT/US04/13878

§ 371 Date: Nov. 1, 2005

Related U.S. Application Data
(60) Provisional application No. 60/467,949, filed on May 5, 2003.

(51) Int. Cl. H04N 5/91

(52) U.S. Cl. 386/46

(57) ABSTRACT

A method for selective control of a device for recording output from a viewing apparatus includes sending output for recording from a viewing apparatus to a recording device selected automatically by the viewing apparatus, responsive to the viewing apparatus being enabled for automatically selecting the recording device; and maintaining recording the output to a recording device designated by the viewing apparatus, responsive to the viewing apparatus being disabled from automatically selecting a recording device.

### FIELD OF THE INVENTION

The present invention relates generally to IEEE-1394 compliant devices and, more particularly, to controlled recording to an interconnected IEEE-1394 compliant device.

### DESCRIPTION OF THE RELATED ART

IEEE-1394, also known as “Firewire”, is a standard for a high-speed connection capable of copy protection, transmitting audio and video over a single cable and transmitting network commands. With two connectors, IEEE-1394 compliant devices can be connected in either a hub or device-to-device style and create a network of IEEE-1394 devices. Not only can a TV with “two-way” IEEE-1394 compliant connectors input (accept) video and audio from compatible IEEE-1394 devices, the TV can also output (send) video and audio via the IEEE-1394 connectors to other IEEE-1394 compliant devices. This two-way input and output connection capability is important for recording from a television TV to a digital video cassette recorder, DVCR, as an example. In addition, the TV can send audio and video control, AV/C, commands to other IEEE-1394 compliant devices in order to control their functions, such as STOP, PAUSE, PLAY, etc.

Interconnecting IEEE-1394 compliant devices to a TV presents the problem of which IEEE-1394 device is to receive a command, such as RECORD, sent by a viewing user. If the TV is not currently tuned to the desired IEEE-1394 compliant device's input on the TV, the command cannot be sent to the correct device. Another problem with multiple IEEE-1394 compliant devices connected to a TV is selecting a particular IEEE-1394 compliant recording device when the user desires to record a program. Known hard disk drives include a device called an Audio Video Hard Disk Drive (AVHDD).

One approach to handling a viewer command is so that every time a RECORD command is received by the TV from a viewer, a pop-up message window would ask the user: “which device from this list do you want the RECORD command to go?” However, this would be tiresome and annoying to the user since most often the user selects the transport commands go to the same IEEE-1394 device, and probably the only IEEE-1394 recording device anyway.

Another past practice is where, upon the TV receiving the RECORD command, the TV is programmed to force the user to “navigate” manually to the TV's input where the audio video hard disk drive AVHDD is connected by pressing CH+/− or INPUT keys. Additionally, existing TV processing of commands could automatically enable automatic tuning when the device was an AVHDD and disable it when it was not an AVHDD. The problem is that sometimes there may not be information available to make this determination accurately or it might not accommodate future devices.

Accordingly, there is a need for selectively controlling, from a viewing device, recording and automatic tuning of an interconnected IEEE-1394 compliant device with user commands in a user intuitive manner.

### SUMMARY OF THE INVENTION

A method for selective control of a device for recording output from a viewing apparatus includes sending output for recording from a viewing apparatus to a recording device selected automatically by the viewing apparatus, responsive to the viewing apparatus being enabled for automatically selecting the recording device; and maintaining recording the output to a recording device designated by the viewing apparatus, responsive to the viewing apparatus being disabled from automatically selecting a recording device.

In a further aspect of the invention, a method by a television apparatus includes determining if a television is pre-selected to output to a recording device; determining if a recording device is designated to record output from the television; determining if the television is tuned to a digital channel responsive to a recording function enabled on a recording device being designated to record output from the television; enabling recording from a viewing apparatus, responsive to the viewing apparatus being tuned to a digital channel; sending output for recording from the television to a recording device selected automatically by the television, responsive to the television being enabled for automatically selecting the recording device; and maintaining recording the output to a recording device designated by the television responsive to the television being disabled from automatically selecting a recording device.

### BRIEF DESCRIPTION OF THE DRAWINGS

A more complete understanding of the present invention may be obtained from consideration of the following description in conjunction with the drawings, in which:

FIG. 1 depicts a diagram of IEEE 1394 complaint devices interconnected to a TV, illustrating an exemplary network for application of the invention;

FIG. 2 depicts an exemplary flow diagram for selective routing of audio video control AV/C transport commands according to the invention; and

FIG. 3 depicts an exemplary user menu for application of the invention to the exemplary network configuration of FIG. 1;

FIG. 4 depicts an exemplary flow diagram for selecting a default IEEE 1394 recording device according to the invention.

To facilitate understanding, identical reference numerals have been used, where possible, to designate identical elements that are common to the figures.

### DETAILED DESCRIPTION

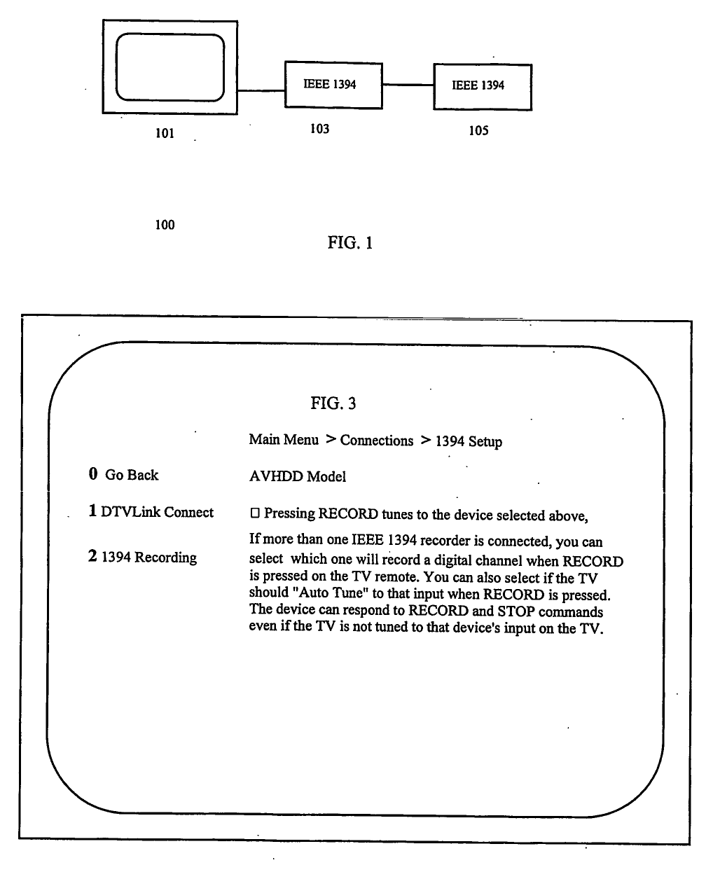

Referring, to the diagram 100 of FIG. 1, there is shown an exemplary interconnection of IEEE-1394 compliant devices 103, 105 connected to a television TV 101. When the IEEE-1394 compliant devices are simply connected to a TV, if the TV is not currently tuned to the desired EEE-1394 device's input on the TV then it may be ambiguous as to which device is receives and is responsive to a viewer command such as RECORD.

The interconnection shown in FIG. 1 is merely an exemplary configuration. Alternatively, the Television can have one, two or more IEEE-1394 connectors that are “two-way” in that not only would they input video from an external source but they would also output video. The benefit to a high definition television HDTV outputting audio and video via an IEEE-1394 compliant connector is that a digital television program received and tuned by the TV can be output to a digital recorder and recorded. Examples of digital recorders include an Audio Video Hard Disk Drive (AVHDD) and a digital video cassette recorder (DVCR).

In an interconnection of IEEE-1394 devices and a TV, several issues of how user controls are handled between the TV and interconnected IEEE-1394 devices must be addressed. One issue is how to tell the TV which device to send transport commands like PLAY and RECORD, when multiple IEEE-1394 devices are connected to the TV. Related to the first problem is how the TV should automatically select a default device for the user so that the user doesn't have to select one if he doesn't want to. Also, another problem with the interconnection of IEEE-1394 complaint devices to a TV is how to use the digital recorder device (e.g., AVHDD) as a quasi-personal video recorder PVR instead of just as a solid-state recorder. A further solution provided by the invention is how to defeat autotuning when its effect is undesirable (i.e., when the user cannot see the TV's video coming back from the IEEE-1394 recorder to be displayed on the TV which prevents the use of the IEEE-1394 recorder as a quasi-PVR).

An advantage to a IEEE-1394 device is that by implementing standardized AV/C (audio video/control) specification into the TV software, the user can use the remote to send control commands to the TV, through the IEEE-1394 network, and to a device without the remote having to be in the same mode as the device being controlled and the remote not having to be programmed to control that brand of device. As an example, the remote can stay in RCA TV mode and still control a Hitachi-brand D-VCR.

The audio video control AV/C specifications are released by the IEEE-1394 Trade Association. The common specification, AVC 98a, defines a set of commands for controlling audio/video devices by using IEEE 1394. It is based on the function control protocol (FCP) defined in IEC61883-1. Beside the common specification, AVC 98a, further documents for specification do exist such as Tuner, Camera, Tape Recorder, Disc, and Monitor.

However, the advantage of being able to control any device with AV/C commands presents a problem: which device on the IEEE-1394 network should receive the commands being sent? One aspect of the invention is that when the TV is tuned to a TV input, which has an IEEE-1394 device connected to it, all AV/C commands would go to the IEEE-1394 device that the TV is currently tuned to. When the TV is not tuned to an IEEE-1394 input, only the RECORD and STOP commands can be sent to the default recording device. However, when tuned to a IEEE-1394 input, the TV can send through any transport control command, regardless of whether the device allows recording or not (e.g., a IEEE-1394 DVD player which does not record and only plays discs). Transport control commands such as PLAY, FORWARD, REVERSE, PAUSE, etc.

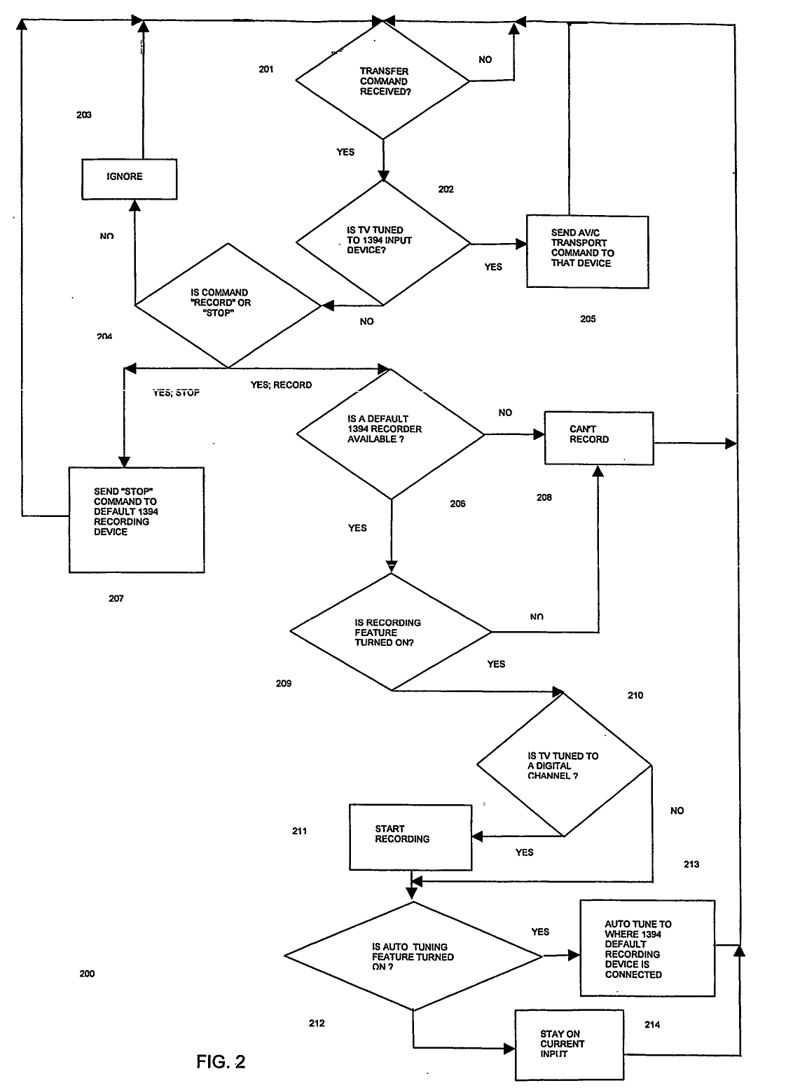

Referring now to FIG. 2, there is shown a process diagram 200 for routing of audio video control AV/C transport commands, in accordance with the invention. While a transfer command has not been received 201 the process of routing commands remains inactive. When a transfer command is received 201 the process checks if the TV is tuned to an IEEE-1394 compliant device 202. If the TV is tuned to a particular EEE-1394 device the transport command received is sent to the 1394 device to which the TV is tuned 205. If the TV is not tuned to a particular IEEE-1394 device then whether the command is a “RECORD” or “STOP” is checked. A command that is neither “RECORD” nor “STOP” is ignored 203. A “STOP” command is sent to the default EEE-1394 recording device 207. In response to a “RECORD” command, the process checks whether a default recorder device is available. 206. The “RECORD” command cannot be carried out if there is no default recorder available 208. Where a default IEEE-1394 recorder is available and the recording feature on the recorder is not turned on 209 the recording function cannot be carried out 208. When the recording feature is activated on the recorder 209 and the TV is tuned to a digital channel 210 the recording operation by the IEEE-1394 recorder is started 211. After the recording is started or when the TV is not tuned to a digital channel a determination is made whether the feature of automatic tuning to a specific IEEE-1394 device is turned on 212. When the automatic tuning feature is not on the TV remains on the current input 214, i.e., connection path. Where the automatic tuning feature is on then the TV is automatically tuned to where the IEEE-1394 device is connected 213.

Again, the advantage of being able to control any device with AV/C commands presents an additional problem. When the TV is not tuned to an input where an IEEE-1394 input is connected, then which IEEE-1394 device on the IEEE-1394 network should the TV send transport commands to when initiating a recording? That has two solutions that are implemented in the TV. One solution is for the TV to survey all available IEEE-1394 devices and automatically select the most appropriate one by applying a set of rules; the other solution is provide a setup menu for the user to select a default IEEE-1394 recording device that the TV send transport commands to when the TV is not tuned to that default IEEE-1394 recording device. Referring to the exemplary menu display of FIG. 3, a viewer is able to successively maneuver from the “Main Menu”, through a “Connections” menu to a “1394 Setup” menu. The viewer has the option of sending the “RECORD” function command to the default IEEE-1394 device, shown as an “AVHDD Model” and maneuver further down the menu display and select a default recording preference. The exemplary text string “Pressing RECORD tunes to the device selected above”, that appears in FIG. 3, is a checkbox control element which if “checked” means that it is enabled, if “unchecked” is disabled. Where AVHDD Model appears is a toggle-able model-selection choice field where highlighting the field and selecting the “OK” button will cause the next 1394 recording device to appear and become the selected device. Continuing to press “OK” will display the next device, and so on. Another selection is “Off”, as already mentioned. One may say the latter is analogous to having multiple printers on a computer network and having to set a default printer that is used for printouts.

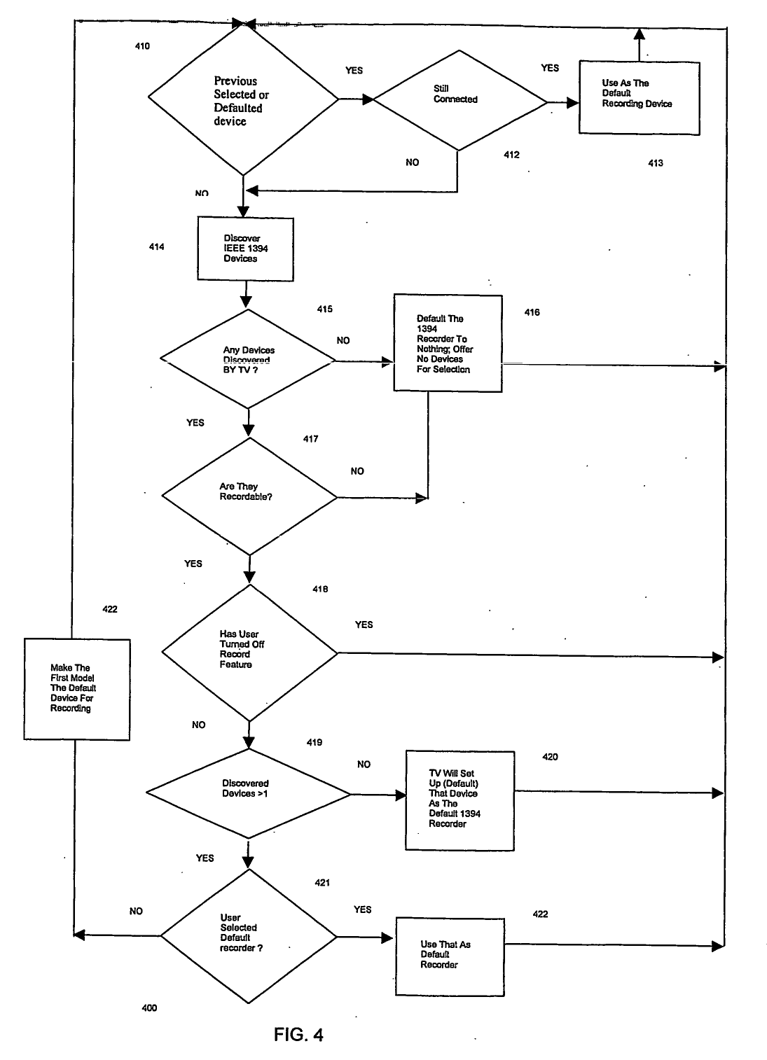

When the TV automatically selects an IEEE-1394 recording default status for a device, it uses a set of rules. The rules or process for selecting a default IEEE-1394 recording device is diagramed in FIG. 4. When a previously selected or defaulted device remains connected to the TV, that TV is used as the default recording device 410, 412, 413. The process directs the TV to discover IEEE-1394 devices 414 where a prior selected or defaulted device does not exist 410 or if it exists in the system the device is not still connected 412. In a condition where no recorder devices are discovered 415 then the 1394 recorder default is set to nothing and no devices are offered for selection as a defaulted device 416. Discovered EEE-1394 devices 415 that are not recordable 417 also results in defaulting the 1394 recorder to nothing 416. A process state of recordable devices 417 leads to a check whether the user has turned off the record feature 418. If the record feature has been turned off 418 the process loops back to the initial query step of determining whether a previous selected or defaulted device exists in response to a new “RECORD” command from the user. If the user has not turned off the record feature 418, and there is only one discovered device 419, the TV will default that device as the default IEEE-1394 recorder device 420. When more than one recorder device is discovered 419 and the user selected a default device 421, the process applies the default recorder status to that user selected device 422. Where the user has not selected a default device 421 among multiple discovered devices 419, the process assigns default recorder status to the first device model identified 422.

FIG. 4 illustrates that only “discovered” IEEE-1394 devices that are capable of EEE-1394 recording (e.g., AVHDD and D-VHS) are considered in any setup as the auto-selected default IEEE-1394 recording device. If there is at least one IEEE-1394 digital recording device connected but the user doesn't want to use the feature, e.g., inadvertent operation concern, a selection “Off” appears in the choice field as a method to ignore the transport keys. If there is only 1 discovered IEEE-1394 digital recording device, then it is the default-selected device, regardless if it's an AVHDD or a DVCR. If there is more than one discovered IEEE-1394 digital recording device and the user has not made a selection, the device selected as a default recorder is the “first” device, by model number, regardless of the type of the device. If the user has chosen a particular target device from the list of devices in the screen and later the device disappears from the network, then valid commands would go to the first device in the list, based on model number. If a chosen device becomes disconnected then the first device in the sorted list now becomes the default device, and if the previous user-selected device comes back online it is made the default device.

Another aspect of the invention is “autotune” to the IEEE-1394 recorder (ideally a hard drive device, sometimes called an Audio Video Hard Disk Drive (AVHDD)) when RECORD is pressed. Autotune means to automatically tune to the input where the AVHDD is connected when the RECORD button is pressed. Doing this allows the user to use the AVHDD as more than just a “digital solid-state hard drive recorder” to record programs: for example, the user can use the AVHDD as a quasi-PVR (time-shifting device); for example, to pause a program, reverse it, forward it, instant replay, skip ahead 30 seconds, etc. It works like this: when the TV is tuned to a digital program (analog not allowed), and the user presses RECORD on the TV remote, the RECORD command is sent via EEE-1394 network to the IEEE-1394 device set as the default recorder. If it did only that, then the AVHDD would only be an expensive solid-state digital VCR. But, because the TV will autotune itself to the default IEEE-1394 recorder's input on the TV when it receives the RECORD command, this allows the user to not only record the program but also to enable trick modes like PAUSE, REVERSE, instant replay, SKIP 30 seconds, etc. This is possible because the TV is outputting IEEE-1394 video from the TV's tuner over to the default recording device, which is then sent back to the TV for display (the routing of the video explains the slight delay when watching the program being sent back from the default recording device).

In an alternative embodiment, anytime the TV has been tuned to a digital channel, a RECORD command would automatically be sent to the audio video hard disk drive AVHDD. That would enable all digital programs to be continuously buffered to the AVHDD. This continuous video buffering would allow the user to use trick modes and to use his AVHDD as a personal video recorder PVR or time-shifting device. The TV could hide the fact that it is automatically tuning to the audio video hard disk drive's IEEE-1394 input on the TV and instead pretend to still be tuned to the digital channel on the TV's tuner.

In a further alternative embodiment, automatic tuning to an IEEE-1394 recording device in response to a RECORD command feature when its effect would be undesirable can be defeated. For a digital video cassette recorder DVCR, a user will want to defeat a command for automatic tuning on RECORD since automatic tuning to the digital video cassette recorder DVCR input isn't helpful since the user won't be able to see the DVCR's output, i.e., the digital channel being recorded from the TV's tuner would not be viewable by the user.

If any EEE-1394 recordable device(s) are connected to the TV but the user doesn't want to make recordings at all, he can disable the RECORD button entirely so that it doesn't inadvertently start an undesired recording. The user can do this by going to the menu screen shown in FIG. 3, instead of selecting a device, like an AVHDD model, in the toggle-able model selection choice field, select “Off”.

In summary, the process of selective control of IEEE-1394 devices includes a solution to provide a setup menu for the user to select a default IEEE-1394 compliant recording device that the TV should transport commands to when the TV is not tuned to that default IEEE-1394 recording device. Another aspect of the invention is when the TV is tuned to an IEEE-1394 input, commands sent over the IEEE-1394 network are always sent to the currently-tuned device.

The selective control of IEEE-1394 devices allows a user to automatically tune, “autotune” to the IEEE-1394 recorder, ideally a hard drive device, sometimes called an Audio Video Hard Disk Drive (AVHDD), when RECORD is pressed. Autotune means to automatically tune to the input where the IEEE-1394 recorder is connected when the RECORD button is pressed. Doing this allows the user to use the AVHDD as more than just a “digital solid-state hard drive recorder”: the user can use the AVHDD as a quasi-PVR (time-shifting device); for example, to pause a program, reverse it, forward it, instant replay, skip ahead 30 seconds, etc.

Additionally, the selective control of IEEE-1394 devices allows the user to turn the autotuning feature off since some devices won't route the video from the TV to the recorder back for the TV to display (e.g., a digital VCR).

Although various embodiments which incorporate the teachings of the present invention have been shown and described in detail herein, those skilled in the art can readily devise many other varied embodiments that will still incorporate these teachings.

1. A method for selective control of a device for recording output from a viewing apparatus, the method comprising the steps of:
(a) sending output for recording from a viewing apparatus to a recording device selected automatically by the viewing apparatus, responsive to the viewing apparatus being enabled for automatically selecting the recording device; and
(b) maintaining recording the output to a recording device designated by the viewing apparatus, responsive to the viewing apparatus being disabled from automatically selecting a recording device.

2. The method of claim 1, further comprising the steps (a′) determining if a viewing apparatus is tuned to a digital channel on the viewing apparatus, responsive to a recording function enabled on a recording device being designated to record output from the viewing apparatus and (a″) enabling recording from a viewing apparatus, responsive to the viewing apparatus being tuned to a digital channel before step (a) is carried out.

3. The method of claim 2, further comprising the steps of determining if a viewing apparatus is pre-selected to output to a recording device, responsive to a command received by the viewing apparatus and determining by the viewing apparatus if a recording device is designated to record output from the viewing apparatus, responsive to the command being a record instruction before step (a′) is carried out.

4. The method of claim 1, wherein the viewing apparatus is a television.

5. The method of claim 1, wherein the recording device is an EEE-1394 compliant device that is one of a digital video cassette recorder DVCR and an audio video hard disk drive AVHDD.

6. The method of claim 1, wherein the viewing apparatus is a television and the recording device is one of a digital video cassette recorder DVCR and an audio video hard disk drive AVHDD.

7. The method of claim 1, wherein the steps (a) though (d) are user menu selections on the viewing apparatus.

8. A method by a television apparatus comprising the steps of:
(a) determining if a television is pre-selected to output to a recording device;
(b) determining if a recording device is designated to record output from the television;
(c) determining if the television is tuned to a digital channel responsive to a recording function enabled on a recording device being designated to record output from the television;
(d) enabling recording from a viewing apparatus, responsive to the viewing apparatus being tuned to a digital channel;
(e) sending output for recording from the television to a recording device selected automatically by the television, responsive to the television being enabled for automatically selecting the recording device; and
(f) maintaining recording the output to a recording device designated by the television responsive to the television being disabled from automatically selecting a recording device.

9. The method according to claim 8, wherein the step of determining if the television is pre-selected to output to a recording device is responsive to a command received by the television.

10. The method of claim 8, wherein the step of determining if a recording device is designated to record output from the television is responsive to responsive to the command being a record instruction.
